(19) United States
(12) Patent Application Publication
(10) Pub. No.: US 2015/0225833 A1
(43) Pub. Date: Aug. 13, 2015

(54) Plasma-Kinetic Spray Apparatus and Method

(71) Applicant: Flame-Spray Industries, Inc., Port Washington, NY (US)

(72) Inventors: Keith A. Kowalsky, Oyster Bay, NY (US); Christopher R. Berghorn, Valley Stream, NY (US); Daniel R. Marantz, Ocean Ridge, FL (US); David J. Cook, Naperville, IL (US); John Conti, Williston Park, NY (US); Raymond M. Schneider, Port Washington, NY (US)

(73) Assignee: Flame-Spray Industries, Inc., Port Washington, NY (US)

(21) Appl. No.: 14/179,052

(22) Filed: Feb. 12, 2014

(51) Int. Cl. C23C 4/12; B05B 7/22

(52) U.S. Cl. CPC C23C 4/127; B05B 7/226

(57) ABSTRACT

A coating system that applies a coating of particles to a surface of an article. The coating system comprises a hybrid plasma torch which may include a cathode, a first plasma gas chamber, a first mixing chamber, a plasma generator for generating an arc column of plasma, a second mixing chamber for mixing a main gas, an at least partially ionized first plasma gas and a second gas that was mixed in the first mixing chamber, wherein the second mixing chamber is dimensioned to receive a plurality of powder particles suspended in a carrier gas, and an accelerator assembly for accelerating the mixture of the main gas, the at least partially ionized first plasma gas, the second plasma gas and the powder particles into a high-velocity stream and for directing the high-velocity stream against the surface of the article. A method of applying the coating of particles is also provided.

### FIELD OF INVENTION

The present invention is directed to a method and apparatus for the low temperature, high velocity particle deposition onto a substrate surface utilizing a plasma-kinetic spray apparatus. Moreover, the present invention is an improved thermal spray method and apparatus in which the in-transit temperature of the powder particles is below their thermal softening point and whereas a cohesive coating is formed by conversion of the kinetic energy of the high velocity particles to elastic deformation of the particles upon impact against the substrate surface at supersonic velocities. In a preferred embodiment, the plasma-kinetic spray apparatus is a hybrid plasma-kinetic spray apparatus.

### BACKGROUND OF THE INVENTION

Until recently it has been the practice with thermal spraying technologies, to use the highest temperature heat sources to spray metal and refractory powders to form a coating on a work piece surface. The highest temperature processes currently in use are plasma spray devices, both using an open arc as well as a constricted arc. These extremely high temperature devices operate at 12,000° F. to 16,000° F. to spray materials, which melt at typically under 3,000° F. Overheating is common with adverse alloying and/or excess oxidation occurring. These problems also occur to a lesser or greater degree during the use of the more recently developed HVOF (high velocity oxy-fuel) processes as well as HVAF (high velocity air-fuel) processes. Both of these are combustion type processes utilizing pure oxygen or air containing oxygen as the oxidizer in the combustion process.

A more recent prior art method of applying a coating is described in U.S. Pat. No. 5,302,414 of A. P. Alkhimov et al, issued Apr. 12, 1994, which describes a cold gas-dynamic spraying method for applying a coating of particles to a work piece surface, the coating being formed of a cohesive layering of particles in solid state on the surface of the work piece. This is accomplished by mixing powder particles having a defined size of from 1 to 50 microns entrained in a cold high pressure carrier gas into a pre-heated high pressure gas flow, followed by accelerating the gas and particles into a supersonic jet to velocities of 300 to 1000 meters per second, while maintaining the gas temperature sufficiently below the melt temperature so as to prevent the melting of the particles. In the operation of this cold gas-dynamic spraying method there are a set of critically defined parameters of operation (particle size and particle velocity for and given material) which makes the process very sensitive to control while maintaining consistent coating quality as well as maintaining useful deposit efficiencies. In addition, the cold gas dynamic spray method as described by Alkhimov et al, is limited to the use of 1-50 micron size powder particles.

Another prior art method of coating is described in U.S. Pat. No. 6,139,913, of T. H. Van Steenkiste et al, which describes a kinetic spray coating method and apparatus to coat a surface by impingement of air or gas with entrained powder particle in a range of up to at least 106 microns and accelerated to supersonic velocity in a spray nozzle and preferably utilizing particles exceeding 50 microns. The use of powder particles greater than 50 microns overcomes the limitation disclosed by Alkhimov et al. Van Steenkiste et al, while utilizing the same general configuration of the prior art in which the cold high pressure carrier gas with entrained powder material is injected downstream of the heating source of the main high pressure gas into the heated main high pressure gas overcomes the limitations of Alkhimov et al by controlling the ratio of the area of the powder injection tube to 1/80 relative to the area of the main gas passage. By controlling this ratio, it limits the relative volume of cold carrier gas flowing into the heated main gas flow, thereby causing a reduced degree of temperature reduction of the heated main high pressure gas. The net temperature of the main high pressure gas when mixed with the carrier/powder gas flow is critical to determining the velocity of the gas exiting the supersonic nozzle and thereby to the acceleration of the powder particles. As indicated by Alkhimov et al, a critical range of particle velocity is required in order that a cohesive coating is formed. The particle size, the net temperature of the gas and the volume of the gas determine the gas dynamics required to produce a particle velocity falling into the critical particle velocity range.

The cold gas dynamic spray method of Alkhimov et al is limited to the use of a particle size range of 1-50 micron. This limitation has been found by Van Steenkiste et al to be due to the heated main high pressure gas being cooled by injecting into it the cold high pressure carrier gas/powder. Because of the reduction in gas temperature, the maximum gas velocity that can be achieved is too low to accelerate powder particles larger than 50 microns to the critical velocity required to achieve the formation of a cohesive coating buildup. Van Steenkiste el al improves on this by limiting the amount of cold high pressure carrier gas being injected into the heated high pressure main gas by defining the ratio of the cross sectional area of the bore of the powder injection tube to the area of mixing chamber. This limited the proportion of cold carrier gas mixed into the heated main gas thereby reducing the degree of temperature reduction of the heated high pressure main gas, which then allows for higher gas velocities to be achieved. This provides the ability to accelerate larger particles of a size range greater than 50 microns to a velocity above the critical velocity required to form a cohesively bonded coating buildup. However, the kinetic spray coating method and apparatus of Van Steenkiste et al state an upper limit of the particle size range 106 microns, based on experimental results.

In addition in Alkimov et. al. the main gas is heated upstream of the nozzle, then just upstream of the throat of the nozzle, the particles and cold carrier gas is introduced, which lowers the final temperature of the combined main gas/carrier gas/particles. This causes the velocity of the particles to be slower than if the temperature of the main gas was not reduced. Accordingly, in Alkimov a much higher main gas temperature must be used to accommodate the cooling effect of the introduction of the cold carrier gas and particles. With standard electric heaters, the main gas temperature can typically be increased to only 1300 to 1400 degrees Fahrenheit. This limits the velocity of the particles and hence the size of the particles that produce cohesively formed coatings. Although the pressures of the gases can be increased to increase the velocity of the particles this also increases the complexity and the expense of the system. Accordingly Alkimov is limited to particle sizes of 1 to 50 microns.

Another prior art spray method and apparatus is described U.S. Pat. No. 7,582,846 by R. J. Metz et al. Described is a method and apparatus which is claimed to produce coatings similar in structure to those produced by the cold spray process of Alkimov but have higher efficiencies and lower gas consumption. This process features a plasma process method of gas heating and a limited cold spray process to accelerate the gas, incorporating these elements into a single hybrid process. However, in fact, this hybrid process states a typical set of operating parameters that represent very high operating costs due to high electrical energy usage (approximately 100 kilowatts) and high usage of costly gas (200 slpm of Helium as well as 100 slpm of Argon).

Another prior art is described in U.S. Pat. No. 6,915,964 of R. M Tapphorn et al. This invention describes an apparatus for solid state deposition and consolidation of powder particles contained in a subsonic or sonic gas jet onto a surface. Under high velocity impact and thermal plastic deformation the powder particles adhesively bond to the substrate and cohesively bond together to form a consolidated material with metallurgical bonds. The powder particles and the surface of the object to be coated are heated to a temperature that causes heat softening of the particles, reducing the yield strength of the particle material and permits plastic deformation upon high velocity impact. The particle heating is controlled to be not so high as to cause any melting of the powder particles. The heating is accomplished by establishing a thermal-transfer plasma generated at ambient pressure (atmospheric pressure) being transferred to the surface to be coated. A thermal plasma is one in which the density of energized ionized plasma particles is very low do to the conditions of operation at or about ambient (atmospheric) pressure and the transfer is such that the thermal plasma is established between the torch and the work piece surface with one of the electrodes of the plasma energizing source being the work piece. In addition, this technology requires that the powder particle temperature be raised such that the particle in brought into a heat soften state and impacted on a work surface at lower velocities (at sonic velocity or below sonic velocity) than particle velocities employed in more conventional cold spray or kinetic spray processes (supersonic).

Other prior art methods and apparatuses employing particle kinetics are described in U.S. Pat. No. 6,861,101, U.S. Pat. No. 6,986,471 and U.S. Pat. No. 7,491,907 all of Kowalsky et al. The Kowalsky et al prior art describes a plasma spray method and apparatus wherein a plasma torch and the plasma apparatus is utilized to produce a hot gas jet stream directed towards a work piece to be coated by first injecting a cold high pressure carrier gas containing a powder material into a cold main high pressure gas flow and then directing this combined high pressure gas flow coaxially around a plasma exiting from an operating plasma generator and converging directly into the hot plasma effluent, thereby mixing with the hot plasma effluent to form a gas stream with a net temperature based on the enthalpy of the plasma stream and the temperature and volume of the cold high pressure converging gas, establishing a net temperature of the gas stream such that the powdered material will not melt or soften, and projecting the powder particles at high velocity onto a work piece surface. The improvement resides in mixing a cold high pressure carrier gas with powder material entrained in it, with a cold high pressure gas flow of gas prior to mixing this combined gas flow with the plasma effluent which is utilized to heat the combined gas flow to an elevated temperature limited to always be less than the softening point or melting point of the powder material. The resulting hot high pressure gas flow is directed through a supersonic nozzle to accelerate this heated gas flow to supersonic velocities, thereby providing sufficient velocity to the particles striking the work piece to achieve a kinetic energy transformation into elastic deformation of the particles as they impact the onto the work piece surface and forming a dense, tightly adhering cohesive coating. Preferably the powder material is of metals, alloys, polymers and mixtures thereof or with semiconductors or ceramics and the powder material is preferably of a particle size range exceeding 50 microns. Kowalsky and Marantz, co-inventors of the Kowalsky prior art are among the inventors of the present invention. Shortcomings of the Kowalsky et al prior art was found to be severe erosion of the plasma system components due to combining the carrier gas and particle mixture with the high pressure, high flow main gas. In addition, it was observed that it would be beneficial to be able to adjust the physical injection point of the powder particle/gas mixture in order to optimize processing conditions for various feedstock materials as well as adjust for particle size distribution of various powder materials. Furthermore it was found there is a significant amount of waste heat energy in the process. In addition it was thought that improvements to the plasma generator would be beneficial to the controllability of the plasma temperature and enthalpy.

### OBJECTS AND SUMMARY OF THE INVENTION

Accordingly, it is an object of the present invention to provide an improved hybrid plasma-kinetic spray apparatus and method for applying a coating utilizing a transferred-arc plasma generator and particle kinetics.

A further object of the invention is to provide a hybrid plasma-kinetic spray apparatus and method in which a supersonic gas jet is created to cause heating of powder particles to a temperature below their melting point and accelerating them to a velocity such that when they impact with the coating surface, their kinetic energy is transformed into plastic deformation of the particles causing them to adhere to the work piece surface and build-up a coating thereby forming a dense coating

A further object of the invention is to provide a method and apparatus for producing high performance well bonded coatings, which are substantially uniform in composition and have very high density with very low oxides content formed within the coating.

Another object of the invention is to provide method and apparatus for reducing cathode erosion due to evaporation of the cathode material and thereby assuring longer operating life of the cathode and improved reliability of the operation of the present invention.

Still another object of the present invention is to provide a method and apparatus having improved energy efficiencies of operation as well reduced cost relative to the use of high cost gases and high volume usages.

And, another object of the present invention is to provide an apparatus with improved durability of the critical component parts.

Another object of the present invention is to provide a capability of adjustability of the injection point of the carrier gas/powder feed stock material prior to being accelerated to supersonic particle velocities.

And another object of the present invention is to provide a smaller more compact and more maneuverability of the plasma/hybrid spray torch.

Still another object of the present invention is to provide capability to control the operating temperature up to 2,500 degrees Fahrenheit in order to provide a broader range of operation.

Another object of the present invention is to provide greater controllability of operating temperatures to adjust for the processing a variety materials having broadly differing melting or softening points.

Still other objects and advantages of the invention will in part be obvious and will in part be apparent from the specification.

To overcome the perceived deficiencies in the prior art and achieve the objectives and advantages above and below, the present invention in a first embodiment is, generally speaking, directed to a coating system that applies a coating of particles to a surface of an article, the coating being formed of cohesive layers of particles in the solid state. In a preferred embodiment, the coating system comprises a plasma-kinetic torch assembly that comprises a cathode; a first plasma gas chamber for receiving a first plasma gas that becomes at least partially ionized therein, wherein the first plasma gas chamber comprises a restricted orifice out of which the at least partially ionized first plasma gas exits; a first mixing chamber for receiving a second plasma gas and the at least partially ionized first plasma gas, wherein the second plasma gas and the at least partially ionized first plasma gas are mixable in the first mixing chamber, and wherein the first mixing chamber acts as a first anode; a plasma generator for generating an arc column of plasma between at least the cathode and the first anode; a second mixing chamber for receiving a main gas that is mixable with the second plasma gas and the at least partially ionized first plasma gas that was mixed in the first mixing chamber, wherein the second mixing chamber is dimensioned to receive a plurality of powder particles suspended in a carrier gas; an accelerator assembly for accelerating the mixture of the main gas, the at least partially ionized first plasma gas, the second plasma gas and the powder particles into a high-velocity stream and for directing the high-velocity stream against the surface of the article; whereby the powder particles are caused to adhere to the article and form the coating of particles.

In another preferred embodiment, a method of applying a coating of cohesive layers of particles to a surface of an article using a coating system is provided, wherein the coating system comprises a plasma-kinetic torch assembly that comprises a cathode; a first plasma gas chamber comprising a restricted orifice; a first mixing chamber, wherein the first mixing chamber acts as a first anode; a plasma generator for generating an arc column of plasma between at least the cathode and the first anode; a second mixing chamber for receiving a main gas that is mixable with the second plasma gas and the at least partially ionized first plasma gas that was mixed in the first mixing chamber, wherein the second mixing chamber is dimensioned to receive a plurality of powder particles suspended in a carrier gas; an accelerator assembly for accelerating the mixture of the main gas, the at least partially ionized first plasma gas, the second plasma gas and the powder particles into a high-velocity stream and for directing the high-velocity stream against the surface of the article; and wherein the method comprises the steps of introducing a first plasma gas into the first plasma gas chamber, wherein the first plasma gas becomes at least partially ionized in the first plasma gas chamber; introducing a second plasma gas and the at least partially ionized first plasma gas into the first mixing chamber and mixing the at least partially ionized first plasma gas and the second plasma gas in the first mixing chamber; generating an arc column of plasma between at least the cathode and the first anode; introducing a main gas into the second mixing chamber, and mixing the main gas with the mixed second plasma gas and the at least partially ionized first plasma gas; introducing a plurality of powder particles suspended in a carrier gas into the second mixing chamber; and accelerating the mixture of the main gas, the at least partially ionized first plasma gas, the second plasma gas and the powder particles into a high-velocity stream and directing the high-velocity stream against the surface of the article; whereby the powder particles are caused to adhere to the article and form the coating of particles.

In another embodiment, the coating system comprises a plasma-kinetic torch assembly in which the torch assembly comprises a cathode; a first plasma gas chamber for receiving a first plasma gas that becomes at least partially ionized therein, wherein the first plasma gas chamber comprises a restricted orifice out of which the partially ionized first plasma gas exits, and wherein the first plasma chamber acts as a first anode, a plasma generator for generating an arc column of plasma between at least the cathode and the first anode; a first mixing chamber for receiving a second plasma gas and the at least partially ionized first plasma gas, wherein the second plasma gas and the at least partially ionized first plasma gas are mixable in the first mixing chamber, and wherein the first mixing chamber acts as a second anode; a plasma generator for generating an arc column of plasma between at least the cathode and the second anode; a second mixing chamber for receiving a main gas that is mixable with the second plasma gas and the at least partially ionized first plasma gas that was mixed in the first mixing chamber, wherein the second mixing chamber is dimensioned to receive a plurality of powder particles suspended in a carrier gas; an accelerator assembly for accelerating the mixture of the main gas, the at least partially ionized first plasma gas, the second plasma gas and the powder particles into a high-velocity stream and for directing the high-velocity stream against the surface of the article; whereby the powder particles are caused to adhere to the article and form the coating of particles.

In another embodiment, a method of applying a coating of cohesive layers of particles to a surface of an article using a coating system is provided, wherein the coating system, which comprises a plasma-kinetic torch assembly that comprises a cathode; a first plasma gas chamber for receiving a first plasma gas that becomes at least partially ionized therein, wherein the first plasma gas chamber comprises a restricted orifice out of which the partially ionized first plasma gas exits, and wherein the first plasma chamber acts as a first anode, a plasma generator for generating an arc column of plasma between at least the cathode and the first anode; a first mixing chamber for receiving a second plasma gas and the at least partially ionized first plasma gas, wherein the second plasma gas and the at least partially ionized first plasma gas are mixable in the first mixing chamber, and wherein the first mixing chamber acts as a second anode; a plasma generator for generating an arc column of plasma between at least the cathode and the second anode; a second mixing chamber for receiving a main gas that is mixable with the second plasma gas and the at least partially ionized first plasma gas that was mixed in the first mixing chamber, wherein the second mixing chamber is dimensioned to receive a plurality of powder particles suspended in a carrier gas; an accelerator assembly for accelerating the mixture of the main gas, the at least partially ionized first plasma gas, the second plasma gas and the powder particles into a high-velocity stream and for directing the high-velocity stream against the surface of the article; whereby the powder particles are caused to adhere to the article and form the coating of particles.

In a specific embodiment, the plasma-kinetic torch assembly is a hybrid plasma-kinetic torch assembly.

The invention accordingly comprises the several steps and the relation of one or more of such steps with respect to the others, and the apparatus embodying features of construction, combination of elements, and arrangement of parts which are adapted to effect such steps, all as exemplified in the following detailed disclosure, and the scope of the invention will be indicated in the claims.

### BRIEF DESCRIPTION OF DRAWINGS

For a fuller understanding of the invention, reference is made to the following description taken in connection with the accompanying drawings in which:

FIG. 1 is a schematic diagram of a Hybrid Plasma-Kinetic Spray system (HPKS) constructed in accordance with an embodiment of the present invention;

FIG. 2A is a schematic diagram view of a HPKS device generally assembled in accordance with an embodiment of the present invention;

FIG. 2B is a schematic diagram view of a HPKS device generally assembled in accordance with an alternate embodiment of the present invention;

FIG. 3 is a cross-sectional view of a HPKS apparatus constructed in accordance with an embodiment of the present invention; and

FIG. 4 is a cross-sectional view of a HPKS apparatus constructed in accordance with an embodiment of the invention in which the powder feed stock material with carrier gas is injected at the convergent point of the flow of main gas mixing with the hot plasma gas.

### DETAILED DESCRIPTION OF THE PREFERRED EMBODIMENTS

Generally speaking, preferred embodiments of the present invention provide methodologies and apparatus by which particles of metals, alloys, polymers and mechanical mixtures of the forgoing and with ceramics and semiconductors having a broad range of particle sizes, may be applied to substrates using a novel hybrid plasma/kinetic spray coating method. The present invention includes a hybrid plasma-kinetic torch assembly comprises a two stage transferred-arc plasma generator section, a cold main gas input assembly, followed by an input section for injection of the powder feedstock/carrier gas mixture into the combined plasma gas/cold gas mixture. The final section of the torch assembly includes an accelerating nozzle into which all of the preceding combined gas flows enter into a convergent portion of the accelerating nozzle, through a critical orifice and finally expanded in a divergent section of the nozzle, causing expansion of the gas and simultaneously accelerating the flow rate of the combined gases to the range of supersonic speed. The method and operation of the present invention provides the ability to raise the temperature of the combined gas flow and powder particles prior to entering the convergent section of the accelerating nozzle to be heated up to a temperature of as high as 2,500 degrees Fahrenheit which is sufficient to allow for the processing of a full range of materials including from low melting materials to very high melting point material and over a full range of useful powder particle sizes, including nano sized particles and up 150 microns and greater.

In addition, the present invention includes a plasma power supply. A system controller, and a gas module used for the control and metering of all of the gas flows as well as cooling water for excessive waste heat removal from the cathode of the plasma generator which is part of the hybrid plasma-kinetic torch. A high pressure powder feeder is also a required system component. Furthermore, services required to support the operation the present invention are gas sources for the carrier gas, main gas, primary plasma gas, and secondary plasma gas as well a source of cooling water and a source of electrical power. Typically, the gases used are defined in Table I.

TABLE I

| | GAS TYPE | FLOW RATE | PRESSURE | |
|---|---|---|---|---|
| Primary Plasma Gas | Nitrogen | 1-3 SCFM | 250-300 | psig |
| Secondary Plasma Gas | Argon | 3-10 SCFM | 240-250 | psig |
| Main Gas | Nitrogen | 10-30 SCFM | 300-1,000 | psig |
| Carrier Gas | Nitrogen | 2-4 SCFM | 250-300 | psig |

In describing the method and apparatus of the present invention, firstly, within the two stage plasma transferred arc generator, a primary cold, high pressure plasma gas is preferably fed in a linear flow manner into the primary stage of the plasma transferred-arc generator wherein a pilot arc is formed internal to the plasma generator. The plasma arc extends from the cathode to the primary plasma nozzle with a constricted orifice on start-up of the plasma generator. The primary plasma exits the primary plasma nozzle through a constricting orifice concentrically located on the centerline of the plasma generator. The plasma arc is then transferred within the generator from the primary plasma nozzle (primary anode) to a secondary plasma nozzle (non-constricted orifice). Additionally, a secondary plasma gas is injected into the primary plasma gas flow as the primary plasma flow exits the pilot anode nozzle. The secondary plasma gas is injected concentric to the centerline of the plasma generator, in a conically vortex manner. This flow regime, converging into the plasma gas exiting from the constricted pilot nozzle creates a venturi effect thereby lowering the operating pressure within the primary plasma nozzle. The resulting benefit of this lowering of the primary gas pressure significantly decreases the erosion rate of the cathode material. In addition, the interaction of the linear flow exiting the primary plasma nozzle and the conical vortex flow of the secondary plasma gas provides for thorough mixing of the two gas flows, raising the temperature of the combined gas flow into the secondary plasma nozzle. In addition, it was found that although the primary gas can be injected in the pilot plasma as a vortex flow surrounding the cathode of the plasma generator but the preferred flow regime would be a linear flow past the cathode. The linear flow significantly extended the cathode life due to a reduction of the erosion of the cathode face. The transferred-arc plasma generator produces a flow of very hot plasma gas exiting the non-constricting secondary anode nozzle. Upon exiting the secondary plasma nozzle the combined high temperature high pressure primary and secondary plasma gas is mixed with a high pressure, high flow of cold main gas. This cold main gas is first caused to flow through an annulus shaped jacket surrounding the outside of the secondary plasma nozzle recovering much of the waste heat energy generated in the secondary anode nozzle. This pre-heats the cold main gas, significantly improving the energy efficiency of the present invention. The pre-heated main gas is further pre-heated by a low energy (4 kilowatt) electric heater, if necessary, after which the pre-heated main gas is directed conically, impinging into the hot plasma flow. Alternatively, the pre-heated main gas can also be directed to flow through a passage surrounding the exterior of the accelerating nozzle further pre-heating the main gas before entering the low energy electric heater. The combine effect of the mixing of the very high temperature plasma gases with the preheated main gas provides for a resulting gas temperature that can be controlled to be in excess of 2,500 degrees Fahrenheit. Further downstream from the plasma generator, powder feedstock entrained in a carrier gas coming from a high pressure powder feeder is injected into the flow of mixed plasma gases and pre-heated main gas. By means of proper controls of the flow rates of the plasma gases, cold main gas and carrier gas as well as the proper control of the plasma power level, the resulting gas temperature and enthalpy of the powder particles can be controllably maintained below the softening or melting point of the particular powder particle material being sprayed. Additionally, the method and apparatus of the present invention allows for adjusting the point that the carrier/powder particle mixture can be injected in to the plasma/main gas mixture prior to entering the convergent section of the accelerating nozzle by means of adjusting the length of the pre-chamber, thus optimizing the residence time of the power particles in the high flow of accelerating gas prior to entering the convergent section of the accelerating nozzle.

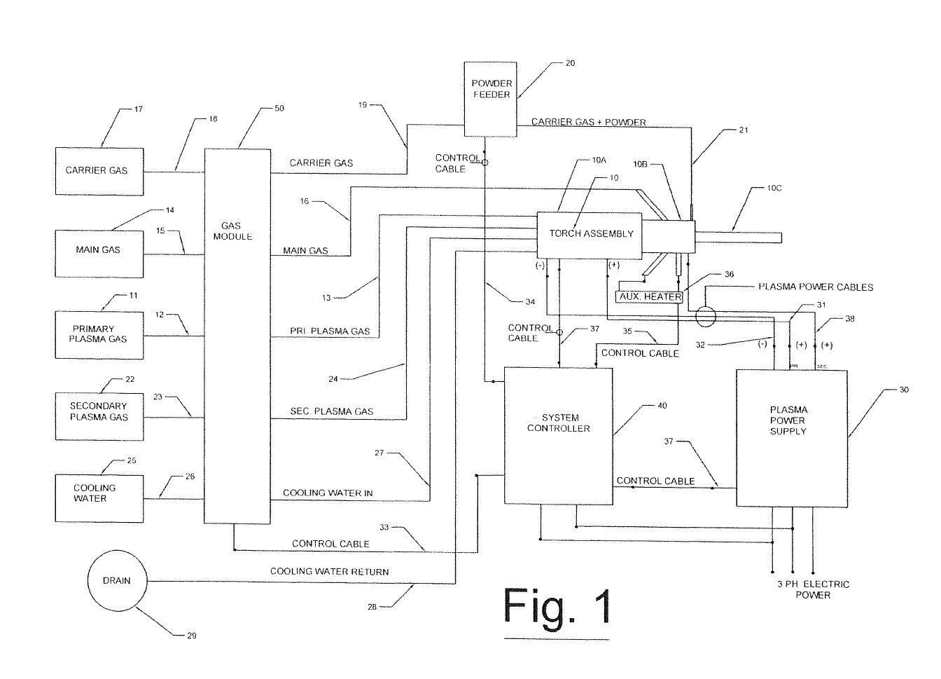

Reference is first made to FIG. 1 in which a HPKS system constructed in accordance with the present invention includes a HPKS apparatus assembly 10, a high pressure powder feeder 20, a plasma power supply 30 (containing a high frequency generator and a dual output D.C. constant current power source), a systems control console 40 and a gas module 50. A high pressure primary plasma gas 11 which is typically, but not limited to argon, nitrogen or a mixture of argon/hydrogen and having a pressure of between 50 psig and 600 psig is fed to gas module 50 through hose 12 and then fed from the gas module 50 through hose 13 to the HPKS torch assembly 10. A secondary plasma gas 22 which is typically, but not limited to argon, nitrogen or a mixture of argon/hydrogen or other non-reactive or reactive gases having a pressure of between 50 psig and 600 psig, is fed through hose 23 to the gas module 50 and then through hose 24 to the HPKS torch assembly 10. The main gas 14, typically but not limited to air, nitrogen, helium or any mixture of these gases and having a pressure of between 200 psig and 600 psig is supplied to the gas module 50 by means of hose 15 and then fed to the HPKS torch assembly through hose 16. The high pressure carrier gas 17 having a pressure of between 200 and 600 psig is supplied to the gas module 50 through hose 18 and then fed from the gas module 50 to the high-pressure powder feeder 20 by means of hose 19. From the high-pressure powder feeder 20 high pressure carrier gas 17 with powder feed stock entrained in it by the high-pressure powder feeder 20 is fed to the HPKS 10 by means of hose 21. A system control assembly 40 controls the plasma power supply 30 by means of control cable 37 as well as the gas module 50 by means of control cable 33 and the high pressure powder feeder 20 by means of control cable 34. In addition the HPKS torch assembly is water cooled by means water flow from the source of cooling water 25 through hose 26 being controlled by the gas module 50 and then through hose 27 to the HPKS torch assembly 10 and then returned to drain 29 through hose 28. Electrical power for the HPKS torch assembly 10 is supplied from the plasma power supply 30 by means of plasma power cables 31, 32 and 38. A auxiliary electrical heater 36, typically but not limited to 4 kilowatts capacity is controlled by means of control cable 35 by the systems controller 40. In addition, a control cable 37 connected between the systems controller 40 and the HPKS torch assembly 10 provides transmission means of data acquisition from the HPKS torch assembly 10 to be collected and stored by the systems controller.

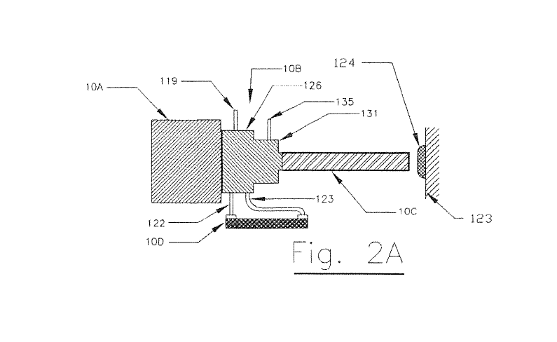

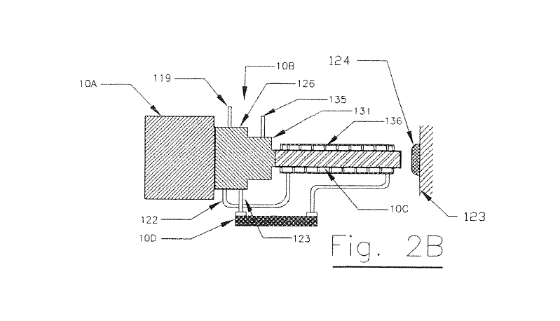

Reference is now made to FIG. 2A in which an enlarged view one embodiment of the overall HPKS torch assembly 10 is shown. The HPKS torch assembly includes a plasma generator 10A which is attached to the plasma transferred-arc/gas mixing nozzle assembly 10B. The outlet of the plasma transferred-arc/gas mixing nozzle assembly 10B is connected to the accelerating nozzle 10C. Additionally, the auxiliary heater assembly 10D is also separately attached to the plasma transferred-arc/gas mixing nozzle assembly 10B.

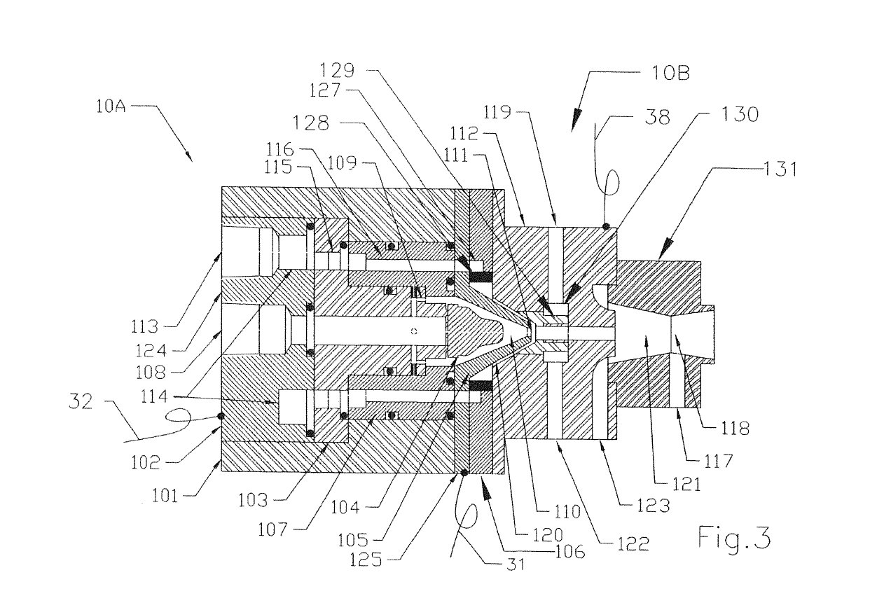

Operationally, FIG. 2A represent a configuration for the HPKS torch assembly 10 which provides for increased energy efficiency as compared to all of the prior art Cold Spray and/or Kinetic spray devices and/or technologies. This higher energy efficiency of operation is accomplished by means of directing the cold main gas which enters the HPKS torch assembly through gas inlet port 119 to flow through an annulus passage 130 (FIG. 3) surrounding the secondary plasma nozzle assembly 129 (FIG. 3). The main gas is thereby pre-heated by removing considerable waste heat generated due to the anode fall energy generated by the transferred-arc attachment to the secondary plasma nozzle assembly 129 (FIG. 3). The main gas, thus preheated gas, flows from gas outlet port 122 (FIG. 3) to the relatively low power auxiliary heater 10D before being injected through gas inlet port 123 to be mixed with the hot ionized plasma gas. As a result of this waste heat energy recovery, overall energy consumption of the HPKS system is significantly reduced.

Reference is now made to FIG. 2B in which an enlarged view of another embodiment of the overall HPKS torch assembly 10 is shown. The HPKS torch assembly includes a plasma generator 10A which is attached to the plasma transferred-arc/gas mixing nozzle assembly 10B. The outlet of the plasma transferred-arc/gas mixing nozzle assembly 10B is connected to the accelerating nozzle 10C which includes a cooling jacket assembly 136 surrounding the outside of the accelerating nozzle 10C. Additionally, the auxiliary heater assembly 10D is also separately attached to the plasma transferred-arc/gas mixing nozzle assembly 10B.

Operationally, FIG. 2B represent an embodiment of the HPKS torch assembly 10 which provides for further increased energy efficiency as compared to the operational energy efficiency of the first embodiment of the present invention as well as to all of the prior art Cold Spray and/or Kinetic spray devices and/or technologies. This higher energy efficiency of operation is accomplished by means of directing the cold main gas which enters the HPKS torch assembly through gas inlet port 119 to flow through an annulus passage 130 (FIG. 3) surrounding the secondary plasma nozzle assembly 129 (FIG. 3). The main gas is thereby pre-heated by removing considerable waste heat generated due to the anode fall energy generated by the transferred-arc attachment to the secondary plasma nozzle assembly 129 (FIG. 3). The main gas, thus preheated gas, flows from gas outlet port 122 to a gas inlet of the cooling jacket 136 which surrounds the accelerating nozzle 10C. The gas flow within the cooling jacket is typically caused to flow in a serpentine manner around the outside of the accelerating nozzle 10C thereby removing waste heat emanating from the accelerating nozzle 10C and further increasing the temperature and thermal energy of the main gas. The outlet port of the cooling jacket is connected to the inlet port of the relatively low power auxiliary heater 10D. Based on the amount of waste heat energy recovered it was found that the auxiliary heater 10D was not always a required element of the HPKS torch assembly 10. In general it was found not to be required except when processing very high melting temperature feed stock materials. However when used, the output port of the auxiliary heater is then connected to the gas inlet port 123 of the plasma/main gas mixer assembly 10B where the pre-heated main gas is converged coaxially with the hot plasma gas flowing axially into the mixing zone within the entrance to the adapter fitting 131 and thus establishing a controlled combined gas temperature/enthalpy to provide for the optimum conditions for producing a high velocity supersonic accelerating gas flow on it's expansion within the accelerating nozzle 10c. As a result of this waste heat energy recovery, overall energy consumption of the HPKS system is further significantly reduced.

Reference is now made to FIG. 3 which is an enlarged cross-sectional view of a plasma generator assembly 10A constructed in accordance with the present invention as it is attached to the plasma transferred-arc/gas mixing nozzle assembly 10B. The plasma generator assembly 10A includes a housing 101 and a gas inlet block 102 which is disposed within the housing 101 coaxially with a cathode support 103. A cathode assembly 104 is attached to the cathode support block 103 and coaxial therewith. A cup-shaped primary plasma nozzle 105 is disposed about cathode assembly 104 and the cathode support block 103 and all are coaxially aligned within the plasma nozzle support block 106 and electrically insulated from the plasma nozzle by means of insulating sleeve 107 also coaxially aligned with the cathode support block 103 and the cathode assembly 104.

Gas inlet block 102 is formed with a primary plasma gas inlet port 108 which receives primary plasma gas and provides its passage through cathode support 103 exiting through ports 109, formed within the cathode support. Ports 109 communicate into a chamber 110 formed between the cathode electrode 104 and the inner surface of the cup shape primary plasma nozzle 105. As the plasma gas exits the ports 109 into chamber 110, which is formed between the cathode assembly 104 and the primary plasma nozzle 105, the plasma gas is caused to flow surrounding the cathode 104 and exits the primary plasma nozzle constricting orifice 111 formed coaxially within the primary plasma nozzle 105.

A cup shaped secondary gas nozzle inlet formed within the plasma/main gas assembly 112 is spatially disposed about the primary plasma nozzle 105 and coaxial with the primary plasma nozzle 105 A high pressure secondary plasma gas is fed into a secondary plasma gas inlet port 113 located in the gas inlet block 102. The secondary high pressure plasma gas flows through the gas inlet block 102 to a manifold 114 within the gas inlet block 102 which then passes through a series of ports 115 within the cathode support 103. The secondary plasma gas is then caused to flow in an evenly distributed manner into and through ports 116 and into a manifold 127 located in the electrical insulator nozzle support block 106. A gas distributor ring 128 is located in the plasma support block 106 and directs the secondary plasma gas to flow in a vortex manner through the space formed between the exterior of the primary plasma nozzle 105 and the cup shaped interior of the secondary plasma nozzle 112. Within the plasma/main gas assembly 112 is a secondary plasma anode nozzle assembly 129 which is coaxially aligned with the central axis of the plasma generator 10B. Surrounding the secondary plasma anode nozzle assembly is an annular space 130. A main gas inlet port 119 is provided which communicates the annular passage 130 and through which main gas flows and discharges through outlet port 122 where it is directed to the auxiliary heater 10D. From the outlet of the auxiliary heater 10D the pre-heated main gas is directed to the inlet gas port 123 within the plasma/main gas mixer assembly 112. The main gas from inlet port 123 is caused to flow towards the central axis and converge and mix with the hot mixture of the primary and secondary plasma gas at a point 121 within the outlet fitting 126 as the combined mixtures flow out of the plasma/main gas mixer assembly 112 A carrier gas and powder inlet tube 117 is located so that it can direct the carrier gas and powder into the main gas flow at a point 118 which is located within the outlet fitting 126 such that this carrier gas and powder mixes with and evenly distributes itself with the plasma/main gas mixture within the plasma/main gas mixer assembly 112. The combined plasma/main gas mixture and carrier gas with the powder particles evenly distributed therein flows into inlet convergent section of the accelerator nozzle 10C (FIG. 2). The negative output of the power supply 30 is connected through lead 32 to the central cathode electrode 104 of the HPKS torch assembly 10. The primary positive output of the power supply 30 is connected to the primary plasma nozzle by means of electrical power lead 31 so that the primary plasma nozzle is an anode. A secondary positive output of power supply 30 is connected to the secondary plasma nozzle/main gas mixer assembly 10B by means of electrical power lead 38.

Downstream from the primary plasma nozzle 105 and coaxially aligned with the primary plasma nozzle 105 and the cup shaped secondary plasma gas/main gas nozzle 112 and additionally coaxially aligned with the secondary plasma gas/main gas nozzle 112 is an extended accelerator nozzle 10C (FIG. 2) which is attached and is a part of the HPKS torch assembly 10. This extended accelerator nozzle 10C is constructed such that its length is at least six (6) times longer than the diameter of its bore. It should be known that the bore of the extended accelerator nozzle 10C can be either a straight bore or a convergent-divergent (Laval) bore The purpose of the extended bore nozzle 10C is to provide a means of causing the total gas flow from the plasma torch 10 with powder particle entrained in the gas to be expanded in a controlled manner and accelerated to supersonic speeds, thereby providing the kinetic energy to the powder particles necessary to form a cohesively bonded coating 124 (FIG. 2) upon impact with the work surface 123 (FIG. 2).

In the operation of the HPKS system, a high pressure primary plasma gas 11 is caused to flow through hose 12 to the gas module 50 and then through hose 13 to the HPKS torch assembly 10. A secondary plasma gas 22 is caused to flow through hose 23 to the gas module and then by means of hose 24 flows to the HPKS torch 10. Additionally high pressure main gas 14 is caused to flow through hose 15 to the gas module 50 and then through hose 16 to the HPKS torch assembly 10. After an initial period of time, typically two seconds, DC power supply 30 is electrically energized as well as a high frequency generator which is internal to the power supply 30 causing a pilot plasma to be momentarily established. This pilot plasma causes the formation of a high-energy DC plasma arc by means of an arc current established between the cathode 104 and the plasma nozzle 105. Instantly with the establishment of the high energy DC pilot plasma, the high frequency generator is de-energized. The DC high energy primary plasma causes a stream of high pressure hot, ionized gas to flow out of the plasma nozzle 105 and into the secondary plasma nozzle 126 through the pilot constricting orifice 111. Upon contacting the walls of the secondary plasma nozzle 129 an extended transferred-arc current is established from the cathode 104 through the pilot constricting orifice 111 to the secondary plasma nozzle 129 and is sustained by DC electrical power supplied from the secondary plasma power supply through electrical lead 38. Simultaneously the secondary plasma gas is caused to flow in a vortex manner through the space formed between the outer surface of the primary plasma nozzle 105 and the inner surface of the converging inlet section of the secondary plasma nozzle 129 and into the secondary plasma nozzle bore and mixing with the hot ionized primary plasma gas and thus producing a large flow of heated ionized flow which is subsequently mixed with main gas 14 which is joined with the plasma at a point downstream 121 and at which the main gas is caused to converge into the flow stream of the hot plasma gas.

By incorporating the extended transferred arc plasma to the secondary plasma nozzle 129 the temperature and enthalpy of the combined primary and secondary plasma gas is controllable. Mixing with the converging cold high pressure main gas downstream in the adapter fitting 131 thereby causing the cold main gas to be heated to a controllably set temperature such that the temperature is maintained at a level as high as possible but below the melting or softening point of the powder material being processes. Maintaining this temperature level below the thermal softening point provides the ability to prevent changes to the metallurgical properties of the powder material being processed and yet impart to the gas stream the highest possible kinetic energy to ultimately produce supersonic gas flow rates upon exiting the accelerator nozzle 10C. Once the plasma has been established in a stable manner, high pressure carrier gas 17 is caused to flow through hose 18 to the gas module 50 and then through hose 19 to the high pressure powder feeder 20. Powder particles of feed stock material are entrained in the carrier gas 17 as it flows through the powder feeder 20 and are caused to flow through hose 21 to the HPKS torch assembly 10 where the high pressure carrier gas 17 with entrained powder enters the HPKS torch assembly 10 through port 117 and is mixed into the temperature controlled high pressure plasma/main gas mixture converging at a point 118 within the adapter fitting 131. The carrier gas 17 with powder particles is distributed within the plasma/main gas flow before the gases exit the adapter fitting 131 and flow into the convergent section of the accelerator nozzle 10C. The mixing of the hot and cold gases results in a gas temperature which is controllable and is based on the volume, temperature and enthalpy of the hot plasma/main gas and the volume and temperature of the carrier/powder gas mixture and is desirably adjusted to a temperature which is as high as possible while not exceeding the thermal softening point of the powder material.

In the preferred embodiment of the present invention the accelerating nozzle 10C the bore of the nozzle is formed as a divergent/convergent (Laval) nozzle. The convergent/divergent (Laval) nozzle comprises three sections, the convergent section 132 and the divergent section 133 and the critical orifice 134. The employment of a convergent/divergent nozzle 10D provides for improved fluid dynamic flow resulting in producing higher velocities of the exiting gas thereby accelerating the powder feedstock entrained within the gas to higher velocities. This higher velocity of the powder feedstock is required to produce improved coating efficiencies as well as higher coating quality.

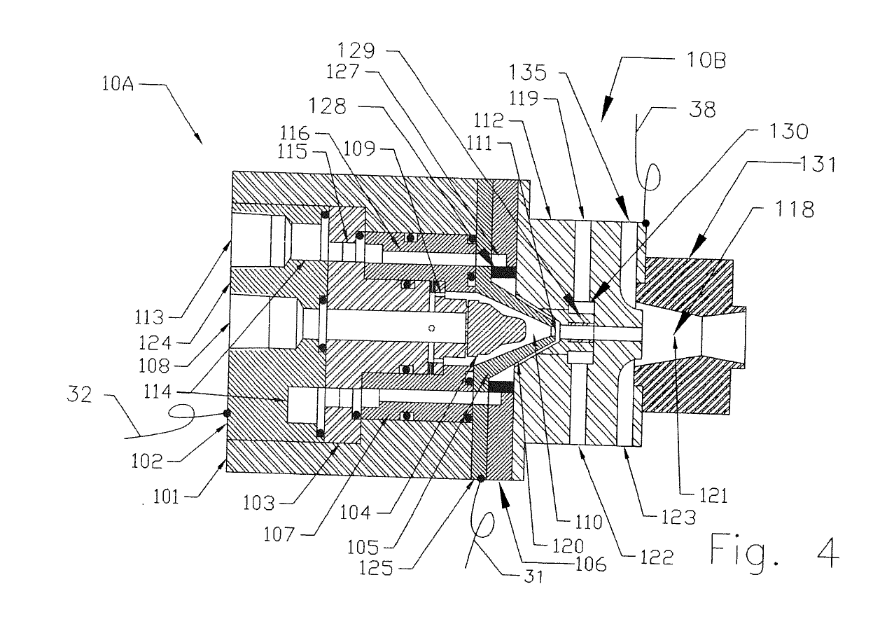

In reference to FIG. 4, this cross-sectional drawing of the HPKS torch assembly is the same as the previously described HPKS torch assembly of this invention as shown in FIG. 3 with the exception that an alternative point 135 is illustrated for the injection of the carrier gas and powder as compared to the injection point 117 as shown in FIG. 3. Like numbers are utilized to indicate like parts. Injecting the carrier gas and powder into the main gas flow at this point 118 provides the same advantage as injecting it at a point downstream at a point 118 of FIG. 2.

It will thus be seen that there are a number of preferred embodiments provided herein, which such preferred embodiments providing a wide range of novel features, functions and methodologies. While the claims set forth just some of the inventive features, others can be found below and are of course therefore made part of the present invention.

For example, provided herein is a method for applying a coating of powder particles to an article, the coating being formed of a cohesive layering of particles in solid state on a surface of the article, the method comprising:

first generating a primary plasma wherein the plasma gas has a pressure of between 50 psig and 600 psig, and subsequently forming a transferred-arc within a secondary plasma generator wherein a secondary plasma gas is caused to flow into the secondary plasma generator in a vortex manner and having a gas pressure of between 50 psig and 600 psig and mixes with primary plasma gas flow forming a combine plasma flow exiting the secondary plasma generator and which is thermally controlled by means of adjusting the energy input to the secondary transferred arc plasma generator and is further interacted in a mixer stage downstream from the secondary transferred arc plasma generator with a unheated or partially pre-heated main gas wherein the main gas has a pressure of between 50 and 600 psig, subsequently heating the colder main gas to an elevated temperature,

subsequently mixing the hot flow of the combined primary gas, secondary gas and the main gas with the powder particles wherein the powder particles have previously been suspended in a carrier gas by means of a separate powder feeder and wherein the total combined gas temperature is below the heat softening temperature of the powder particles, and

subsequently accelerating the heated mixture of gases and particles into a supersonic jet and directing the jet of gases and particles in a solid state against the article so that the particles are caused to adhere to the article and build the cohesive coating.

Other specific embodiments may comprise one or more of the following:
The method as broadly disclosed above, where the primary plasma gas pressure is 250 psig and/or wherein the secondary plasma gas pressure is between 240 psig to 250 psig;
The method as broadly disclosed above, wherein the primary plasma gas is caused to flow into the primary plasma generator stage in a laminar manner;
The method as broadly disclosed above, wherein the total combined gas temperature is above the melting point of the powder particles;
The method as broadly disclosed above, wherein the powder particles are of a size range of less than 150 microns;
The method as broadly disclosed above, wherein the step of controlling the temperature of the mixture of gases and particles is performed by adjusting the enthalpy of the secondary plasma flame;
The method as broadly disclosed above, wherein the particle have a particle size in excess of 50 microns;
The method as broadly disclosed above, wherein the mixture of primary and secondary plasma gases, main gas and carrier gas and powder particles are mixed to heat the particles to a temperature below the particles thermal softening temperature in order to form a coating of adhesively bonded particle splats;
The method as broadly disclosed above, wherein the mixture of primary and secondary plasma gases, main gas and carrier gas and powder particles are mixed to heat the particles to a temperature above the particles melting point in order to form a coating of adhesively bonded particle splats;
The method as broadly disclosed above, wherein the particles are accelerated to a velocity of from about 300 to about 1,200 meters/second;
The method as broadly disclosed above, wherein the primary and secondary plasma gas, carrier gas and main gas are selected from the group consisting of air, nitrogen, helium, argon or a mixture thereof;
An article made by the method broadly disclosed above;
The method as broadly disclosed above, wherein the powder particles are of at least one first material selected from the group of a metal, alloy, mechanical mixture of a metal and an alloy, or a mixture of at least one of a polymer, a ceramic and a semiconductor with at least one of a metal, alloy and a mixture of a metal and an alloy;
The method as broadly disclosed above, wherein the main gas has a pressure of 300 psig;
The method as broadly disclosed above, wherein the carrier gas has a pressure between 50 psig and 600 psig;
The method as broadly disclosed above, wherein the unheated main gas is first caused to flow around the outside of the secondary transferred arc nozzle in a manner to remove excess heat form said nozzle; and/or
The method as broadly disclosed above, wherein the powder particles in a heat soften state or a fully melted state are accelerated into a supersonic jet and directing the jet of gases and particles in said state against the article so that the particles are caused to adhere to the article and build the cohesive coating.

As but another example, disclosed herein a method of applying a coating to an article, the coating being formed of a cohesive layering of the powder particles in solid state on the surface of the article, the method comprising:

first generating a two stage plasma comprising a primary plasma stage followed by a secondary transferred arc plasma stage and a mixing chamber whereby the output of the two stage plasma generator enters a first mixing chamber wherein a main gas is mixed with the combined plasma gases and wherein the enthalpy of the plasma gases is controlled so that the temperature of the combined gas flow of plasma gases and main gas is controllably selectable, and,

second, mixing the powder particles and a carrier gas, which are of at least one first material selected from the group consisting of a metal, alloy, mechanical mixture of a metal and an alloy or a mixture of at least one of a polymer, a ceramic and a semiconductor with at least one of a metal, alloy and a mixture of a metal and an alloy, and;

third, mixing said powder particles and carrier gas with said heated main gas and combined plasma gases in a second mixing chamber, thereby heating the mixture of gases and particles to an elevated temperature, which temperature is controlled to be below the thermal softening temperature of the particles; and

fourth, accelerating the mixture of elevated temperature gases and particles into a supersonic jet having a velocity of from about 300 to about 1,200 m/sec; and directing the supersonic jet of gas and particles in a solid state against an article of a second material selected from the group consisting of a metal, alloy, semiconductor, ceramic and plastic, and a mixture of any combination thereof, thereby coating the article with a desired thickness of particles.

In specific embodiments, the method may comprise one or more of the following:
The method as broadly disclosed above, wherein the primary plasma gas pressure is 250 psig;
The method as broadly disclosed above, wherein the secondary plasma gas pressure is between 240 psig to 250 psig;
The method as broadly disclosed above, wherein the secondary plasma gas is caused to flow into the secondary plasma generator stage in a laminar manner;
The method as broadly disclosed above, wherein the total combined gas temperature is above the melting point of the powder particles;
The method as broadly disclosed above, wherein the powder particles are of a size range of less than 150 microns,
The method as broadly disclosed above, wherein the step of controlling the temperature of the mixture of gases and particles is performed by adjusting the enthalpy of the secondary plasma flame;
The method as broadly disclosed above, wherein the particle have a particle size in excess of 50 microns;
The method as broadly disclosed above, wherein the mixture of primary and secondary plasma gases, main gas and carrier gas and powder particles are mixed to heat the particles to a temperature below the particles thermal softening temperature in order to form a coating of adhesively bonded particle splats;
The method as broadly disclosed above, wherein the mixture of primary and secondary plasma gases, main gas and carrier gas and powder particles are mixed to heat the particles to a temperature above the particles melting point in order to form a coating of adhesively bonded particle splats;
The method as broadly disclosed above, wherein the particles are accelerated to a velocity of from about 300 to about 1,200 meters/second;
The method as broadly disclosed above, wherein the primary and secondary plasma gas, carrier gas and main gas are selected from the group consisting of air, nitrogen, helium, argon or a mixture thereof;
An article made by the method broadly disclosed above;
The method as broadly disclosed above, wherein the powder particles are of at least one first material selected from the group of a metal, alloy, mechanical mixture of a metal and an alloy, or a mixture of at least one of a polymer, a ceramic and a semiconductor with at least one of a metal, alloy and a mixture of a metal and an alloy;
The method as broadly disclosed above, wherein the main gas has a pressure of 300 psig;
The method as broadly disclosed above, wherein the powder particles are of at least one first material selected from the group of a metal, alloy, mechanical mixture of a metal and an alloy, or a mixture of at least one of a polymer, a ceramic and a semiconductor with at least one of a metal, alloy and a mixture of a metal and an alloy;
The method as broadly disclosed above, wherein the main gas has a pressure of 300 psig;
The method as broadly disclosed above, wherein the carrier gas has a pressure between 50 psig and 600 psig;
The method as broadly disclosed above, wherein the unheated main gas is first caused to flow around the outside of the secondary transferred arc nozzle in a manner to remove excess heat form said nozzle; and/or
The method as broadly disclosed above, wherein the powder particles in a heat soften state or a fully melted state are accelerated into a supersonic jet and directing the jet of gases and particles in said state against the article so that the particles are caused to adhere to the article and build the cohesive coating.
   In yet another preferred embodiment, a portable coating system is disclosed, which applies a coating of particles to an article, the coating being formed of cohesive layers of particles in solid state on the surface of the article, comprising:

at least one mixing chamber, which receives powder particles, a carrier gas and a main gas and forms a mixture of gases and particles, and;

a two stage plasma generator, which comprises a primary plasma stage and a secondary plasma stage followed by a mixing chamber which mixes the combined plasma flows with a main gas whereby the mixture is heated to an elevated temperature, which temperature is controlled by means of the energy input to the secondary plasma transferred arc stage to be below the thermal softening temperature of the particles, and

an accelerator which accelerates the heated mixture of gases and particles into a supersonic jet and directs the jet of gases and particles in a solid state against the article so that the particles are caused to adhere to the article and form the cohesive coating.

In specific embodiments, the system may comprise one or more of the following:
The system as broadly disclosed above, wherein the primary plasma flame is coaxially fed into the secondary transferred arc plasma stage and further joined with a main unheated or partially heated gas and with a carrier gas with powder particles entrained therein and where the combined mixture is controllably heated to a temperature below the thermal softening temperature of the particles in order to form a coating of adhesively bonded particle splats;
The system as broadly disclosed above, wherein the combined gas and particle mixture is controllably heated to a temperature above the softening or melting temperature of the particles;
The system as broadly disclosed above, wherein the carrier gas has a pressure between 50 psig and 600 psig;
The system as broadly disclosed above, wherein the main gas has a pressure between 50 psig and 600 psig;
The system as broadly disclosed above, wherein the particle have a particle size in excess of 50 microns;
The system as broadly disclosed above, wherein the particles are of a size range, which is less than about 150 microns;
The system as broadly disclosed above, wherein the temperature of the mixture of gases and particles is controlled by adjusting the enthalpy of the secondary transferred arc plasma flame;
The system as broadly disclosed above, wherein the powder particles are of at least one first material selected from the group of a metal, alloy, mechanical mixture of a metal and an alloy, and a mixture of at least one of a polymer, a ceramic and a semiconductor with at least one of a metal, alloy and a mixture of a metal and an alloy;
The system as broadly disclosed above, wherein the particles are accelerated to a velocity of from about 300 to about 1,200 meters/second;
The system as broadly disclosed above, wherein the carrier gas and main gas are selected from the group consisting of air, nitrogen, helium or a mixture thereof; and/or
The system as broadly disclosed above, wherein the primary and secondary plasma gases are selected from the group consisting of argon, argon/hydrogen or nitrogen.
   In yet another preferred embodiment, a hybrid plasma/kinetic spray apparatus for applying a coating to an article is disclosed, wherein the apparatus comprises:

a two stage plasma generator which includes a cathode support member, supporting a cathode thereon, a cup shaped primary plasma nozzle having an inner surface disposed about the cathode and the inner surface forming a chamber into which a primary plasma forming gas is introduced for passage through the cup shaped plasma nozzle, the plasma gas exiting the cup shaped nozzle through an orifice, subsequently entering into a secondary plasma stage comprised of a cup shape secondary plasma nozzle having a cup shaped inner surface, wherein the cup shaped inner surface coaxially surrounds the exterior of the primary plasma nozzle and spaced from the primary plasma nozzle forming a narrow conically shaped gap through which a secondary plasma forming gas is introduced in a vortex manner and combining with the primary plasma upon entering into and through the secondary plasma nozzle, and:

an electrical D.C. power source with suitable constant current type operating characteristics providing a negative connection to said cathode and a first positive connection to said primary plasma nozzle of said plasma generator, energizing said primary plasma generator, which causes a plasma arc to be formed between said cathode and said primary plasma nozzle causing said plasma gas to be heated and to exit said primary plasma nozzle in a plasma state and enters the secondary nozzle, and a second positive electrical connection to said secondary plasma nozzle of said two stage plasma generator causing a plasma transferred arc to be formed from said cathode to said secondary plasma nozzle by means of the primary plasma further heating both the primary and secondary plasmas and

a main gas is converged coaxially into the combined primary and secondary plasma flows as this combined plasma exits the secondary plasma nozzle into a first mixing chamber and

further downstream, following the combining of the primary and secondary plasmas and said main gas, within a second mixing chamber, a carrier gas with entrained powder particle material is injected into the combined hot gas stream, and

located following the injection point of said carrier gas with entrained powder particle within the second mixing chamber, a converging/diverging nozzle is positioned coaxially with said plasma nozzle and main gas nozzle, having an entry chamber into which said plasma gases and said main gas and carrier gas with powder particles entrained therein flow and combine to establish a gas mixture having a temperature which is the result of the enthalpy of said plasma gases and said main gas, said gas mixture accelerating through the extended bore of said accelerating nozzle to a supersonic velocity so that upon impact onto the surface of said article a cohesively bonded coating will form and build-up.

Specific embodiments of the apparatus may comprise one or more of the following:
The apparatus as broadly disclosed above, wherein the accelerating nozzle has a straight bore;
The apparatus as broadly disclosed above, wherein the accelerating nozzle is a de Laval nozzle;
The apparatus as broadly disclosed above, further comprising a powder feeder which injects said powder particles into said carrier gas flow prior to mixing with said main gas and plasma gas mixture;
The apparatus as broadly disclosed above, further comprising an operative to control said main gas pressure, said plasma gas flow, and said plasma generator;
The apparatus as broadly disclosed above, further comprising means of removal of excess heat from the secondary plasma anode nozzle utilizing the flow of main gas and providing means preheating the main gas;
The apparatus as broadly disclosed above, further comprising means of excess heat removal from the exterior of the accelerating nozzle utilizing the flow of main gas and providing means of preheating main gas;
The apparatus as broadly disclosed above, further comprising means for injecting the powder and carrier gas at the same injection location as the main gas injection;
The apparatus as broadly disclosed above, further comprising primary plasma gas flow is directed in a laminar manner over the cathode;
The apparatus as broadly disclosed above, wherein the primary gas flow is directed in a vortex manner over the cathode; and/or
The apparatus as broadly disclosed above, wherein the secondary plasma gas is directed in a laminar manner into the secondary plasma nozzle.

To be sure, the present invention is also directed to the plasma-kinetic torch assembly itself and to a method of applying a coating of cohesive layers of particles to a surface of an article using such a plasma-kinetic torch assembly, wherein the plasma-kinetic torch assembly in a preferred embodiment comprises a cathode; a first plasma gas chamber for receiving a first plasma gas that becomes at least partially ionized therein, wherein the first plasma gas chamber comprises a restricted orifice out of which the at least partially ionized first plasma gas exits; a first mixing chamber for receiving a second plasma gas and the at least partially ionized first plasma gas, wherein the second plasma gas and the at least partially ionized first plasma gas are mixable in the first mixing chamber, and wherein the first mixing chamber acts as a first anode, a plasma generator for generating an arc column of plasma between at least the cathode and the first anode; a second mixing chamber for receiving a main gas that is mixable with the second plasma gas and the at least partially ionized first plasma gas that was mixed in the first mixing chamber, wherein the second mixing chamber is dimensioned to receive a plurality of powder particles suspended in a carrier gas; an accelerator assembly for accelerating the mixture of the main gas, the at least partially ionized first plasma gas, the second plasma gas and the powder particles into a high-velocity stream and for directing the high-velocity stream against the surface of the article; whereby the powder particles are caused to adhere to the article and form the coating of particles.

It will thus be seen that the objects set forth above, among those made apparent from the preceding descriptions, are efficiently attained and, since certain changes may be made in carrying out the above method and in the constructions set forth without departing from the spirit and the scope of the invention, it is intended that all matter contained in the above descriptions and shown in the accompanying drawings shall be interpreted as illustrative and not in a limiting sense.

It is also to be understood that the following claims are intended to cover all the generic and specific features of the invention herein described and all statements of the scope of the invention, which, as a matter language, might be said to fall there between.

What is claimed is:

1. A coating system that applies a coating of particles to a surface of an article, the coating being formed of cohesive layers of particles in the solid state, the coating system comprising a plasma-kinetic torch assembly comprising:
a cathode;
a first plasma gas chamber for receiving a first plasma gas that becomes at least partially ionized therein, wherein the first plasma gas chamber comprises a restricted orifice out of which the at least partially ionized first plasma gas exits;
a first mixing chamber for receiving a second plasma gas and the at least partially ionized first plasma gas, wherein the second plasma gas and the at least partially ionized first plasma gas are mixable in the first mixing chamber, and wherein the first mixing chamber acts as a first anode,
a plasma generator for generating an arc column of plasma between at least the cathode and the first anode;
a second mixing chamber for receiving a main gas that is mixable with the second plasma gas and the at least partially ionized first plasma gas that was mixed in the first mixing chamber, wherein the second mixing chamber is dimensioned to receive a plurality of powder particles suspended in a carrier gas;
an accelerator assembly for accelerating the mixture of the main gas, the at least partially ionized first plasma gas, the second plasma gas and the powder particles into a high-velocity stream and for directing the high-velocity stream against the surface of the article;
whereby the powder particles are caused to adhere to the article and form the coating of particles.

2. The coating system as claimed in claim 1, wherein the plasma generator generates an arc column of plasma between the cathode and the restricted orifice.

3. The coating system as claimed in claim 1, comprising a main gas preheating assembly comprising:
a passage that surrounds the first mixing chamber, wherein the passage receives the main gas from a main gas inlet port and wherein the main gas is heated in the passage by heat generated from the arc column of plasma between the cathode and the first anode;
an outlet port, coupled to the passage, for receiving the main gas that has been heated in the passage;
a heater, coupled to the outlet port, for receiving the main gas that exits the outlet port and for further heating the main gas; and
a main gas inlet port, coupled between the heater and the second mixing chamber, for providing the passage of the heated main gas from the heater into the second mixing chamber.

4. The coating system as claimed in claim 1, comprising a main gas preheating assembly comprising:
a passage that surrounds the first mixing chamber, wherein the passage receives the main gas from a main gas inlet port and wherein the main gas is heated in the passage by heat generated from the arc column of plasma between the cathode and the first anode;
an outlet port, coupled to the passage, for receiving the main gas that has been heated in the passage;
a cooling jacket, coupled to the outlet port and positioned around at least part of the accelerating assembly, for receiving the main gas that exits the outlet port, facilitating the removal of heat emanating from the accelerating assembly and increasing the temperature of the main gas in the cooling chamber; and
a main gas inlet port, coupled between the cooling jacket and the second mixing chamber, for providing the passage of the heated main gas from the cooling chamber into the second mixing chamber.

5. The coating system as claimed in claim 1, comprising a main gas preheating assembly comprising:
a passage that surrounds the first mixing chamber, wherein the passage receives the main gas from a main gas inlet port and wherein the main gas is heated in the passage by heat generated from the arc column of plasma between the cathode and the first anode;
an outlet port, coupled to the passage, for receiving the main gas that has been heated in the passage;
a cooling jacket, coupled to the outlet port and positioned around at least part of the accelerating assembly, for receiving the main gas that exits the outlet port, facilitating the removal of heat emanating from the accelerating assembly and increasing the temperature of the main gas in the cooling chamber;
a heater, coupled to the cooling jacket, for receiving the main gas that exits the cooling jacket and for further heating the main gas; and
a main gas inlet port, coupled between the heater and the second mixing chamber, for providing the passage of the heated main gas from the heater into the second mixing chamber.

6. A method of applying a coating of cohesive layers of particles to a surface of an article using a coating system comprising a plasma-kinetic torch assembly comprising a cathode; a first plasma gas chamber for receiving a first plasma gas and further comprising a restricted orifice; a first mixing chamber, wherein the first mixing chamber acts as a first anode and receives a second plasma gas; a plasma generator for generating an arc column of plasma between at least the cathode and the first anode; a second mixing chamber for receiving a main gas that is mixable with the second plasma gas and the at least partially ionized first plasma gas that was mixed in the first mixing chamber, wherein the second mixing chamber is dimensioned to receive a plurality of powder particles suspended in a carrier gas; an accelerator assembly for accelerating the mixture of the main gas, the at least partially ionized first plasma gas, the second plasma gas and the powder particles into a high-velocity stream and for directing the high-velocity stream against the surface of the article; wherein the method comprises the steps of:
introducing a first plasma gas into the first plasma gas chamber, wherein the first plasma gas becomes at least partially ionized in the first plasma gas chamber;
introducing a second plasma gas and the at least partially ionized first plasma gas into the first mixing chamber and mixing the at least partially ionized first plasma gas and the second plasma gas in the first mixing chamber;
generating an arc column of plasma between at least the cathode and the first anode;
introducing a main gas into the second mixing chamber, and mixing the main gas with the mixed second plasma gas and the at least partially ionized first plasma gas;
introducing a plurality of powder particles suspended in a carrier gas into the second mixing chamber; and
accelerating the mixture of the main gas, the at least partially ionized first plasma gas, the second plasma gas and the powder particles into a high-velocity stream and directing the high-velocity stream against the surface of the article;
whereby the powder particles are caused to adhere to the article and form the coating of particles.

7. The method as claimed in claim 6, wherein the coating system comprises a main gas preheating assembly comprising a passage that surrounds the first mixing chamber, wherein the passage receives the main gas from a main gas inlet port and wherein the main gas is heated in the passage by heat generated from the arc column of plasma between the cathode and the first anode; an outlet port, coupled to the passage, for receiving the main gas that has been heated in the passage; a heater, coupled to the outlet port, for receiving the main gas that exits the outlet port and for further heating the main gas; and a main gas inlet port, coupled between the heater and the second mixing chamber, for providing the passage of the heated main gas from the heater into the second mixing chamber, wherein the method comprises the steps of:
introducing the main gas into the passage and heating the main gas in the passage;
further heating the main gas in the heater; and
introducing the further heated main gas into the second mixing chamber.

8. The coating system as claimed in claim 6, comprising a main gas preheating assembly comprising a passage that surrounds the first mixing chamber, wherein the passage receives the main gas from a main gas inlet port and wherein the main gas is heated in the passage by heat generated from the arc column of plasma between the cathode and the first anode; an outlet port, coupled to the passage, for receiving the main gas that has been heated in the passage; a cooling jacket, coupled to the outlet port and positioned around at least part of the accelerating assembly, for receiving the main gas that exits the outlet port, facilitating the removal of heat emanating from the accelerating assembly and increasing the temperature of the main gas in the cooling chamber; and a main gas inlet port, coupled between the cooling jacket and the second mixing chamber, for providing the passage of the heated main gas from the cooling chamber into the second mixing chamber, wherein the method comprises the steps of:
introducing the main gas into the passage and heating the main gas in the passage;
further heating the main gas and removing heat emanating from the accelerating assembly by passage of the main gas through the cooling jacket; and
introducing the further heated main gas into the second mixing chamber.

9. The coating system as claimed in claim 1, wherein the plasma-kinetic torch assembly is a hybrid plasma-kinetic torch assembly.
